(19) United States
(12) Patent Application Publication
(10) Pub. No.: US 2026/0336462 A1
(43) Pub. Date: Oct. 29, 2026

(54) POWER ADJUSTMENT METHOD BASED ON CHARGING PILES, SYSTEM, ELECTRONIC DEVICE AND STORAGE MEDIUM

(71) Applicant: Autel Digital Power Co., Ltd., Shenzhen (CN)

(72) Inventors: Lina LIANG, Shenzhen (CN); Yuqin ZHANG, Shenzhen (CN); Jinlei ZHANG, Shenzhen (CN); Chao WU, Shenzhen (CN)

(73) Assignee: Autel Digital Power Co., Ltd., Shenzhen (CN)

(21) Appl. No.: 19/532,275

(22) Filed: Feb. 6, 2026

Related U.S. Application Data
(63) Continuation of application No. PCT/CN2024/110343, filed on Aug. 7, 2024.

(30) Foreign Application Priority Data
Aug. 10, 2023 (CN) 202311009970.3

(51) Int. Cl. B60L 53/67; B60L 53/16; B60L 53/62; B60L 53/63; B60L 53/66; B60L 53/68

(52) U.S. Cl. CPC B60L 53/67; B60L 53/16; B60L 53/62; B60L 53/63; B60L 53/66; B60L 53/68

(57) ABSTRACT

Provided is a power adjustment method, including: determining a priority identifier of a target charging gun in a target charging pile; determining a setpoint power of the target charging gun based on the priority identifier; acquiring a reported power of the target charging gun; and controlling the target charging pile to perform a power release operation or a power recovery operation on the target charging gun based on the setpoint power and the reported power.

### CROSS-REFERENCE TO RELATED APPLICATIONS

This application is a continuation of PCT patent Application No. PCT/CN2024/110343, filed on Aug. 7, 2024, which claims the priority to the Chinese Patent Application No. 202311009970.3, filed on Aug. 10, 2023. The entire disclosures of the aforementioned applications are incorporated herein by reference for all purposes.

### BACKGROUND

With the explosive growth of electric devices such as new energy electric vehicles, the demand for charging devices such as charging piles has increased accordingly. A static allocation strategy is used for current intelligent scheduling of charging pile power, which only triggers power reallocation when a new vehicle owner joins charging or a vehicle owner completes charging.

However, during the charging process where the usage environment of the charging pile does not change, there will be a certain deviation between the actual power required by the vehicle for charging and the actual supplied power by the charging pile, and the traditional static allocation strategy is difficult to solve the problem of calibrating power deviation, leading to power overload or power redundancy of the charging pile.

### SUMMARY

The present disclosure provides a power adjustment method based on charging piles, a system, an electronic device, and a storage medium.

According to a first aspect, the present disclosure provides a power adjustment method based on charging piles, including: determining a priority identifier of a target charging gun in a target charging pile; determining a setpoint power of the target charging gun based on the priority identifier; acquiring a reported power of the target charging gun; and controlling the target charging pile to perform a power release operation or a power recovery operation on the target charging gun based on the setpoint power and the reported power.

According to a second aspect, the present disclosure provides an electronic device, including a memory, a processor, and a computer program stored in the memory and capable of running on the processor, where the processor, when executing the computer program, implements the method as described in the first aspect.

According to a third aspect, the present disclosure provides a non-transitory storage medium, where the storage medium stores a computer program, and the computer program implements the method according to the first aspect when executed by a processor.

According to a fourth aspect, the present disclosure provides a power adjustment system based on charging piles, including a charging management device and a charging station, where the charging station includes at least one charging group, each charging group includes at least two charging piles, the charging management device is communicatively connected to the charging station, and the charging management device is configured to execute the method according to the first aspect.

### BRIEF DESCRIPTION OF DRAWINGS

One or more embodiments are illustrated by way of example with the corresponding figures in the accompanying drawings. These illustrative descriptions do not constitute a limitation on the embodiments. Elements with the same reference numerals in the drawings denote similar elements. Unless otherwise specified, the figures in the drawings do not constitute a limitation on scale.

FIG. 1 is a schematic diagram of an application environment of a power adjustment system based on charging piles according to one or more embodiments of the present disclosure;

FIG. 2 is a schematic flowchart of a power adjustment method based on charging piles according to one or more embodiments of the present disclosure;

FIG. 3 is a schematic flowchart of performing a power release operation or a power recovery operation on a target charging gun according to one or more embodiments of the present disclosure;

FIG. 4 is a schematic flowchart of determining a setpoint power of a target charging gun according to a priority identifier according to one or more embodiments of the present disclosure; and

FIG. 5 is a schematic diagram of an architecture of a computer device according to one or more embodiments of the present disclosure.

### DETAILED DESCRIPTION

The technical solutions in the embodiments of the present disclosure will be clearly and completely described below with reference to the accompanying drawings in the embodiments of the present disclosure. The described embodiments are part of the embodiments of the present disclosure, rather than all the embodiments. Based on the embodiments in the present disclosure, all other embodiments, including modifications based on the principles of the present disclosure, fall within the protection scope of the present disclosure.

First, to introduce the method of the present disclosure, some key terms involved in the following are defined.

Setpoint power: a theoretical charging power value set for a charging gun to provide to a device to be charged.

Reported power: an actual charging power value detected for a charging gun to provide to a device to be charged.

Maximum power value: the maximum power value that a charging gun has in a normal working state, when an actual charging power value of a charging gun is greater than a maximum power value, the charging gun is more likely to be damaged compared to a normal working state.

Minimum reserved power value: the minimum power value that a charging gun has in a normal working state, when an actual charging power value of a charging gun is less than the minimum reserved power value, the charging gun cannot start charging.

Below is an introduction to the present disclosure environment of the methods provided in the embodiments of the present disclosure.

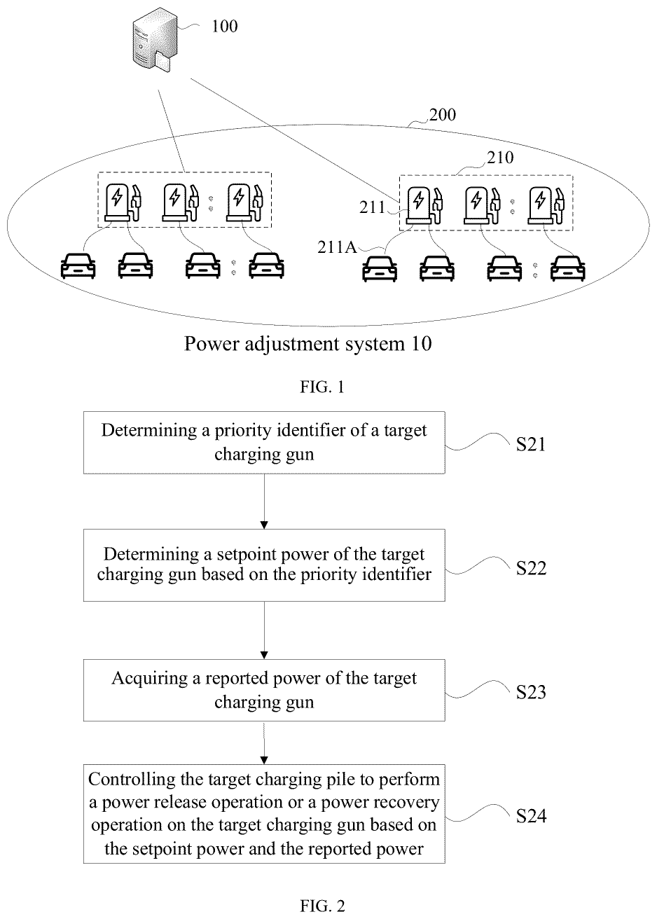

The method provided by the embodiment of the present disclosure can be applied to the power adjustment system based on charging piles as shown in FIG. 1. The power adjustment system 10 includes a charging management device 100 and a charging station 200. The charging station 200 includes at least one charging group 210. One charging group 210 includes at least two charging piles 211. Each charging pile 211 includes a plurality of charging guns 211A. Each charging gun 211A can match one user at the same time to charge the user's device, such as a new energy electric vehicle.

The charging management device 100 is communicatively connected to the charging station 200 for managing the charging station 200. The charging management device 100 may include one or more workstations or servers, and implement monitoring, data collection, and query of the charging piles 211 and the charging guns 211A, as well as data processing and analysis of the entire charging station 200, etc. The charging management device 100 can acquire data including equipment information of devices being charged in the charging station 200, charging information of the charging pile 211 including the charging gun 211A, and user information corresponding to the charging device.

In an embodiment, the charging station 200 is a facility that provides charging services for electric vehicles in cities, highways, or industrial areas. The charging station 200 includes two charging groups 210, which are respectively the first charging group and the second charging group. The allocation of the charging group 210 may be completed by the charging management device 100; for example, the charging management device 100 may divide the charging pile 211 using the same power supply point into one charging group 210.

Each charging group 210 may include at least two charging piles 211; for example, the first charging group 210 includes three charging piles 211, which are respectively the first charging pile, the second charging pile and the third charging pile. Each charging pile further includes a plurality of charging guns 211A; for example, the first charging pile includes four charging guns 211A, which are respectively the first charging gun, the second charging gun, the third charging gun and the fourth charging gun. The charging gun 211A is used to electrically connect the electric vehicle to be charged with the charging pile 211, so that the charging pile 211 provides power for the electric vehicle to charge through the charging gun 211A.

The charging pile 211 and the charging gun 211A can provide charging outputs with different powers, which are specifically controlled by the charging management device 100 over the setpoint power of the charging pile 211 and the charging gun 211A to realize power adjustment for the electric vehicle.

It is understandable that the composition of the charging station and charging management device shown in the above FIG. 1 is merely an example. In actual situations, equipment or modules may be integrated, adjusted, or added as needed. For example, the charging station may further include a power supply system, which mainly provides power for charging equipment and may consist of primary equipment (switches, transformers, lines, etc.), secondary equipment (including detection, protection, and control devices, etc.), source filtering devices, etc., which is not limited by the present disclosure.

Based on the above power adjustment system, the power adjustment method based on the charging piles provided in the present disclosure can be implemented.

FIG. 2 is a schematic flowchart of a charging power distribution method provided by an embodiment of the present disclosure; the power adjustment method shown in FIG. 2 may be performed by the charging management device, and the method may include:
S21, determining a priority identifier of a target charging gun.

The target charging pile includes multiple charging guns including the target charging gun, each charging gun has one corresponding priority identifier, and the priority identifier is used to determine the position of the corresponding charging gun in the adjustment sequence when adjusting power.

In an embodiment, the priority identifiers are classified into four levels, corresponding to four different user types respectively, which are users with paused charging, users with priority charging, VIP users, and regular users. That is, four different types of users have different priority identifiers, and have different sequences when allocating and adjusting charging power, and the specific sequence will be described in detail later.

The priority identifiers may include levels which are not limited to the four levels in the embodiments; more levels may also be provided to correspond to other user types, such as VVIP users or whitelisted customers, which is not limited herein.

The priority identifier may be adjustable; when the user information corresponding to the target charging gun or the charging status changes, the priority identifier is also adjusted accordingly, and thus it is necessary to re-determine the priority identifier of the target charging gun.
S22, determining a setpoint power of the target charging gun based on the priority identifier.

The target charging pile has a power upper limit, and the target charging pile cannot support all the charging guns included in the charging pile to output at maximum power due to its power upper limit; thus, it is necessary to allocate the setpoint power for each charging gun of the charging pile. Since the priority identifiers assigned to respective charging guns are different, the setpoint power of all charging guns including the target charging gun can be determined based on the difference in priority identifiers.

In an embodiment, the target charging pile includes 4 charging guns, each charging gun has a maximum power of 10 kw, the target charging pile has a power upper limit of 20 kw, then it cannot satisfy that all 4 charging guns charge at the maximum power of 10 kw. At this time, according to the priority identifier, the setpoint power of one of the charging guns is allocated to 0 kw, the setpoint power of one charging gun is allocated to 10 kw, the setpoint power of one charging gun is allocated to 2 kw, and the setpoint power of the remaining one charging gun is allocated to 8 kw.

In the present embodiment, the target charging gun may be any one of the four charging guns, thereby realizing determining the setpoint power of the target charging gun according to the priority identifier.
S23, acquiring a reported power of the target charging gun.

After the charging gun determines the setpoint power, it then charges the charging device according to the setpoint power. The charging gun synchronously collects and obtains its reported power while outputting charging.

In fact, due to the difference between actual working conditions and theoretical states, the reported power is not strictly equal to the setpoint power; as long as the deviation between the two is within a certain fluctuation range, it is acceptable, that is, the charging gun is deemed to be in a normal working state. However, if the actual charging power of the charging gun deviates significantly from the set setpoint power, it is indicated that there is an abnormality in the operation of the charging gun, and it is necessary to adjust the power or shut down for maintenance; and only by real-time detection to acquire the reported power and by comparing the reported power with the setpoint power can the detection of the working status of the target charging gun be achieved.

In an embodiment, the setpoint power allocated by the charging pile to the target charging gun is 10 kw, the reported power detected by the charging gun is 9 kw, the deviation between the two is 1 kw, this deviation value is within the acceptable fluctuation range, thus, it can be determined that the charging gun is working normally, and there is no need to adjust the power temporarily.

In another embodiment, the setpoint power allocated by the charging pile to the target charging gun is 10 kw, the reported power detected by the charging gun is 6 kw, the deviation between the two is 4 kw, which has far exceeded the acceptable fluctuation range, and it is necessary to perform step S24 on the charging gun to adjust the power.

The detection of reported power may be performed in real time, or sampling can be performed at time intervals. Regardless of the detection method used, the obtained reported power corresponds to the setpoint power used for comparison, that is, the time for comparing the obtained reported power should not be earlier than the time when the setpoint power is adjusted.
S24, controlling the target charging pile to perform a power release operation or a power recovery operation on the target charging gun based on the setpoint power and the reported power.

In an embodiment, after determining that the target charging gun requires power adjustment, it is necessary to judge a fault type of the target charging gun based on the comparison between the setpoint power and the reported power, and then perform the corresponding power adjustment operation according to the fault type of the target charging gun, where the power adjustment operation is one of a power release operation and a power recovery operation.

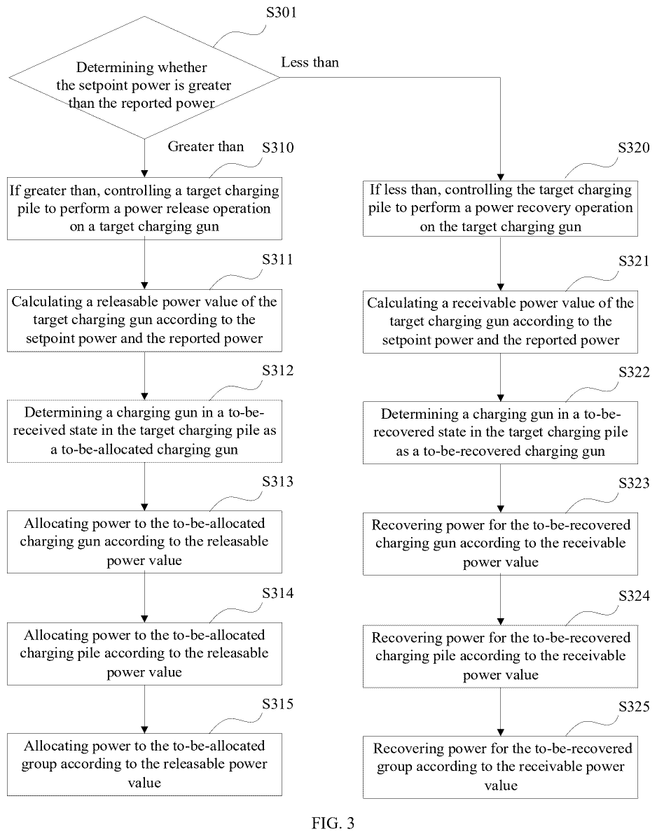

FIG. 3 is a schematic flowchart of performing a power release operation or a power recovery operation on a target charging gun according to an embodiment of the present disclosure, and the method includes the following steps:
S301, determining whether the setpoint power is greater than the reported power.

When the setpoint power of the target charging gun is greater than the reported power, it is indicated that the target charging gun belongs to the type with abnormally high setpoint power, and the following step S310 is executed. When the setpoint power of the target charging gun is less than the reported power, it is indicated that the target charging gun is of the type where the setpoint power is abnormally low, and the following step S320 is executed.
S310, in response to determining that the setpoint power is greater than the reported power, controlling a target charging pile to perform a power release operation on a target charging gun. Specifically, step S310 includes:
S311, calculating a releasable power value of the target charging gun according to the setpoint power and the reported power.

The purpose of performing a power release operation on the target charging gun is to put the target charging gun in a normal working state, specifically, the final reported power of the target charging gun is the same as the adjusted setpoint power, or the deviation between the two is within an acceptable fluctuation range.

It can thus be determined that, in order to reduce the setpoint power value to the reported power value, the releasable power value of the target charging gun is the result of the setpoint power value minus the reported power value, i.e., releasable power value=setpoint power value−reported power value.

In an embodiment, the setpoint power value is 10 kw, the reported power value is 6 kw, and then the calculated releasable power value is 4 kw.
S312, determining a charging gun in a to-be-received state in the target charging pile as a to-be-allocated charging gun.

When the power of the target charging gun decreases, it is indicated that the target charging pile has additional power redundancy, which can be allocated to other charging guns, thereby improving the overall charging efficiency of the target charging pile, and thus, it is necessary to determine whether the charging guns in the target charging pile other than the target charging gun can receive the releasable power value.

In an embodiment, in an embodiment, S312 includes the following steps:
S3121, acquiring the setpoint power and the maximum power value of the charging gun in the target charging pile.
S3122, determining whether the setpoint power is less than the maximum power value.

When the setpoint power is less than the maximum power value, proceed to the following step S3123. When the setpoint power is greater than or equal to the maximum power value, then proceed to the following step S3124.
S3123, in response to determining that the setpoint power is less than the maximum power value, determining the charging gun as a to-be-allocated charging gun.

When the setpoint power is less than the maximum power value, it is indicated that the charging gun is not working at full load, thus it can be determined that the charging gun is a to-be-allocated charging gun to increase the setpoint power of the charging gun and improve charging efficiency.
S3124, in response to determining that the setpoint power is greater than or equal to the maximum power value, determining that the charging gun is not the to-be-allocated charging gun.

When the setpoint power is greater than or equal to the maximum power value, it is indicated that the charging gun is already working at full load or even overload. If the setpoint power of the charging gun continues to be increased, it may easily cause damage to the charging gun or other safety accidents; therefore, it is necessary to confirm that the charging gun is not the to-be-allocated charging gun.

In another embodiment, S312 includes the following steps:
S3125, acquiring the setpoint power and the reported power of the charging gun in the target charging pile.
S3126, determining whether a difference between the setpoint power and the reported power is less than a preset threshold.

When the difference between the setpoint power and the reported power is less than a preset threshold, proceed to the following step S3127; when the difference between the setpoint power and the reported power is greater than the preset threshold, proceed to the following step S3128.
S3127, in response to determining that the difference between the setpoint power and the reported power is less than the preset threshold, determining the charging gun as the to-be-allocated charging gun.

When the difference between the setpoint power and the reported power is less than a preset threshold, it is indicated that the charging gun is in a normal working state, its power can be adjusted, and thus determining that the charging gun is the to-be-allocated charging gun.
S3128, in response to determining that the difference between the setpoint power and the reported power is greater than or equal to the preset threshold, determining that the charging gun is not the to-be-allocated charging gun.

When the difference between the setpoint power and the reported power is greater than or equal to the preset threshold, it is indicated that this charging gun also belongs to the type with abnormally high setpoint power, and it is necessary to perform a power release operation on it, rather than allowing this charging gun to receive additional power from another target charging gun with abnormally high setpoint power; therefore, it is determined that this charging gun is not a to-be-allocated charging gun.

The methods for determining the to-be-allocated charging gun in the above two embodiments may be used alone or in combination with each other.
S313, allocating power to the to-be-allocated charging gun according to the releasable power value.

In an embodiment, in an embodiment, S313 includes the following steps:
S3131, determining the setpoint power and the maximum power value of the to-be-allocated charging gun.
S3132, determining a maximum receivable value of the to-be-allocated charging gun according to the setpoint power and the maximum power value.

The maximum setpoint power of the to-be-allocated charging gun during normal operation is the maximum power value, which is the maximum setpoint power of the to-be-allocated charging gun after increasing power; thus, it can be determined that the maximum receivable value of the to-be-allocated charging gun is the result of subtracting the setpoint power value from the maximum power value, i.e., maximum receivable value=maximum power value−setpoint power value.
S3133, allocate power to the to-be-allocated charging gun according to the maximum receivable value or the releasable power value.

Since both the maximum receivable value and the releasable power value play a restrictive role in the allocated power, that is, the increased power allocated to the to-be-allocated charging gun cannot exceed the maximum receivable value to avoid safety accidents caused by damage to the charging gun, and meanwhile, the increased allocated power also cannot exceed the releasable power value to avoid the target charging gun not having sufficient redundant power to release, resulting in overload of the target charging pile.

In an embodiment, to solve the above problem, S3133 further includes the following steps:
S31331, determining whether the maximum receivable value is less than the releasable power value.
S31332, in response to determining that the maximum receivable value is greater than or equal to the releasable power value, increasing the setpoint power of the to-be-allocated charging gun according to the releasable power value.

When the maximum receivable value is greater than or equal to the releasable power value, it is indicated that the to-be-allocated charging gun is sufficient to fully receive the releasable power value of the target charging gun; in this case, the setpoint power is increased for the to-be-allocated charging gun with the releasable power value, and the setpoint power of the target charging gun is reduced to reach the reported power value.
S31333, in response to determining that the maximum receivable value is less than the releasable power value, increasing the setpoint power of the to-be-allocated charging gun according to the maximum receivable value.

When the maximum receivable value is less than the releasable power value, it is indicated that even if the to-be-allocated charging gun is increased to the maximum power value, it cannot fully receive the releasable power value of the target charging gun. At this time, the setpoint power for the to-be-allocated charging gun is increased based on the maximum receivable value, and the setpoint power of the to-be-allocated charging gun is increased to reach the maximum power value.
S31334, recalculating the releasable power value of the target charging gun according to the maximum receivable value and the releasable power value.

When increasing the setpoint power for the to-be-allocated charging gun according to the maximum receivable value, this indicates that the to-be-allocated charging gun cannot fully receive the releasable power value of the target charging gun; therefore, it is necessary to allocate power to another to-be-allocated charging gun, and thus it is necessary to recalculate the releasable power value of the target charging gun.

In an embodiment, the releasable power value of the target charging gun at this time is the original releasable power value minus the maximum receivable value of the allocated to-be-allocated charging gun, that is, recalculated releasable power value=original releasable power value−maximum receivable value.

In the embodiment, the first to-be-allocated charging gun is referred to as the charging gun among the to-be-allocated charging guns that has not yet been allocated power, and the second to-be-allocated charging gun is referred to as the charging gun among the to-be-allocated charging guns that has already been allocated power. The original releasable power value of the target charging gun is 4 kw, and the maximum received power value of the second to-be-allocated charging gun is 1 kw, so the recalculated releasable power value is 3 kw. For the first to-be-allocated charging gun, the recalculated 3 kw is used as the releasable power value for subsequent calculations and judgments.

There may be multiple first to-be-allocated charging guns, and the specific number is not limited. For example, in the present embodiment, the maximum receiving power values of the two first to-be-allocated charging guns are respectively 2 kw and 1 kw, and the recalculated releasable power value is 1 kw.
S31335, allocating power to the first to-be-allocated charging gun according to the recalculated releasable power value.

In an embodiment, in this step, it is necessary to judge again the magnitude between the releasable power value of the target charging gun and the maximum receivable value of the first to-be-allocated charging gun, and allocate power to the first to-be-allocated charging gun according to the judgment result; the specific process thereof may refer to step S313, and details are not repeated here.

In some embodiments, after step S313, the method further includes:
S314, allocating power to the to-be-allocated charging pile according to the releasable power value. The method specifically includes:
S3141, determining whether the releasable power value is available in the target charging pile.

After the target charging pile allocates power to all its to-be-allocated charging guns, it is still possible that the setpoint power of the target charging gun has not yet reached the reported power, requiring further release of additional power. Specifically, the target charging pile still has a releasable power value, that is, the releasable power value is greater than 0; therefore, it is necessary to further judge whether the releasable power value is 0; if it is not 0, the following step S3142 is performed; if it is 0, the following step S3145 is performed.
S3142, in response to determining that the releasable power value is available in the target charging pile, determining a group including the target charging pile as a target group.
S3143, determining the charging pile in the to-be-received state in the target group as the to-be-allocated charging pile.

Due to the structure of the power adjustment system, the algorithm difficulty and loss of power distribution among charging piles belonging to the same group are both superior to those of power distribution among charging piles in different groups. Therefore, when there is a releasable power value in the target charging pile, the group containing the target charging pile is determined as the target group, and the charging piles in the same target group that are in the to-be-received state are determined as to-be-allocated charging piles.

In an embodiment, it is determined whether the setpoint power of each charging pile in the target group has reached the power upper limit of the charging pile; if so, it is determined that the charging pile is not a to-be-allocated charging pile; if not, it is determined that the charging pile is the to-be-allocated charging pile.
S3144, allocating power to the to-be-allocated charging pile according to the releasable power value.

For the charging gun of the to-be-allocated charging pile, power is allocated to the charging gun according to the releasable power value; the specific process can refer to steps S312 and S313, which will not be repeated here.
S3145, when the target charging pile does not have a releasable power value, ending step S310.

When there is no releasable power value in the target charging pile, it is indicated that the setpoint power of the target charging gun has been adjusted to the reported power, and the target charging pile has completed the power release operation, so the power release operation step can be ended.

In some embodiments, after step S3144, the method further includes:
S315, allocating power to the to-be-allocated group according to the releasable power value. The method specifically includes:
S3151, determining whether the releasable power value is available in the target group.

After the target group allocates power to all its to-be-allocated charging piles, it is still possible that the setpoint power of the target charging gun has not yet reached the reported power, requiring further release of additional power. Specifically, the target group still has a releasable power value, that is, the releasable power value is greater than 0; therefore, it is necessary to further judge whether the releasable power value is 0; if it is not 0, the following step S3152 is performed; if it is 0, the following step S3154 is performed.
S3152, in response to determining that the releasable power value is available in the target group, determining other groups in the to-be-received state as to-be-allocated groups.

In an embodiment, it is determined whether the overall setpoint power of groups other than the target group has reached the power upper limit of the group; if so, it is determined that the group is not a to-be-allocated group; if not, it is determined that the group is a to-be-allocated group.
S3153, allocating power to the to-be-allocated group according to the releasable power value.

For the charging piles in the to-be-allocated group, refer to step S3143 to determine the to-be-allocated charging piles in the to-be-allocated group, power is allocated to the charging guns in the to-be-allocated charging piles according to the releasable power value; the specific process can refer to steps S312 and S313, and will not be repeated here.

In some embodiments of the present disclosure, if after step S3153, the target charging gun still has a releasable power value, that is, the releasable power value is greater than 0, the final setpoint power of the target charging gun after releasing power in step S310 is the setpoint power minus the allocated power value, or it can be calculated according to the setpoint power being the reported power plus the unallocated power.
S3154, in response to determining that no releasable power value is available in the target group, ending step S310.

When there is no releasable power value in the target group, it is indicated that the setpoint power of the target charging gun has been adjusted to the reported power, and the target group has completed the power release operation, so the power release operation step can be ended.

Please refer to FIG. 3 again. Another step S320 relative to S310 will be introduced, which follows S301.
S320, in response to determining that the setpoint power is less than the reported power, controlling the target charging pile to perform a power recovery operation on the target charging gun. Specifically, step S320 includes:
S321, calculating a receivable power value of the target charging gun according to the setpoint power and the reported power.

The purpose of performing a power recovery operation on the target charging gun is to put the target charging gun in a normal working state, specifically, the final reported power of the target charging gun is the same as the adjusted setpoint power, or the deviation between the two is within an acceptable fluctuation range.

It can thus be determined that, in order to increase the setpoint power value to the reported power value, the receivable power value of the target charging gun is the result of subtracting the setpoint power value from the reported power value, i.e., receivable power value=reported power value−setpoint power value.

In an embodiment, the setpoint power value is 4 kw, the reported power value is 7 kw, and then the calculated receivable power value is 3 kw.
S322, determining a charging gun in a to-be-recovered state in the target charging pile as a to-be-recovered charging gun.

When the power of the target charging gun increases, it is indicated that the target charging pile may cause a power overload phenomenon, and it is necessary to reduce the setpoint power of other charging guns to keep the overall setpoint power of the target charging pile from exceeding the theoretical upper limit; thus, it is necessary to determine whether the charging guns in the target charging pile other than the target charging gun can reduce their power to offset the increased receivable power value and maintain the normal operation of the target charging pile.

In an embodiment, S322 includes the following steps:
S3221, acquiring the setpoint power and a minimum reserved power value of the charging gun in the target charging pile.
S3222, determining whether the setpoint power is greater than the minimum reserved power value.

If the setpoint power is greater than the minimum reserved power value, proceed to the following step S3223; if the setpoint power is less than or equal to the minimum reserved power value, proceed to the following step S3224.
S3223, in response to determining that the setpoint power is greater than the minimum reserved power value, determining the charging gun as the to-be-recovered charging gun.

When the setpoint power is greater than the minimum reserved power value, it is indicated that the charging gun has not yet reached the minimum load operation, and the setpoint power can be further reduced to recover part of the power of the charging gun and provide it to the target charging gun, thus determining the charging gun as a to-be-recovered charging gun.
S3224, in response to determining that the setpoint power is less than or equal to the minimum reserved power value, determining that the charging gun is not a to-be-recovered charging gun.

When the setpoint power is less than or equal to the minimum reserved power value, it is indicated that the charging gun is already in the minimum load working state, or even lower than the minimum load working state. If the setpoint power of the charging gun continues to be reduced, it will easily cause the charging gun to stop working directly or perform ineffective work; therefore, it is necessary to determine that the charging gun is not a to-be-recovered charging gun.

In another embodiment, S322 includes the following steps:
S3225, acquiring the setpoint power and the reported power of the charging gun in the target charging pile.
S3226, determining whether a difference between the setpoint power and the reported power is greater than a preset threshold.

When the difference between the setpoint power and the reported power is greater than a preset threshold, proceed to the following step S3227; when the difference between the setpoint power and the reported power is less than or equal to the preset threshold, proceed to the following step S3228.
S3227, in response to determining that the difference between the setpoint power and the reported power is greater than the preset threshold, determining the charging gun as the to-be-recovered charging gun.

When the difference between the setpoint power and the reported power is greater than the preset threshold, it is indicated that the charging gun is in a normal working state, or the charging gun falls into the category of abnormally high setpoint power, and its setpoint power can be subjected to recovery adjustment; thus, the charging gun is determined as a to-be-recovered charging gun.

In an embodiment, the setpoint power of the charging gun is 6 kw, the reported power is 5 kw, the deviation is +1 kw, which is greater than the threshold value of 0, and the charging gun is in a normal working state, so it is determined that the charging gun is a to-be-recovered charging gun.

In another embodiment, the setpoint power of the charging gun is 9 kw, the reported power is 5 kw, with a deviation of +4 kw, which is greater than the threshold value of 0. Although the charging gun is not in a normal working state but belongs to an abnormally high setpoint power, it can still be determined that the charging gun is a to-be-recovered charging gun.

In another embodiment, the setpoint power of the charging gun is 2 kw, the reported power is 5 kw, with a deviation of −2 kw, which is less than the threshold value 0, the charging gun has abnormally low setpoint power, and it is determined that the charging gun is not a to-be-recovered charging gun.
S3228, in response to determining that the difference between the setpoint power and the reported power is less than or equal to the preset threshold, determining that the charging gun is not a to-be-recovered charging gun.

When the difference between the setpoint power and the reported power is less than or equal to the preset threshold, it is indicated that this charging gun also belongs to the type of abnormally low setpoint power, and it is necessary to increase the setpoint power of this charging gun rather than letting this charging gun continue to reduce the setpoint power to recover power for the target charging gun; therefore, it is determined that this charging gun is not a to-be-recovered charging gun. For determining the to-be-recovered charging gun in the above two embodiments may be used alone or in combination with each other.
S323, recovering power for the to-be-recovered charging gun according to the receivable power value.

In an embodiment, S323 includes the following steps:
S3231, determining the priority identifier of the to-be-recovered charging gun.

In an embodiment, each to-be-recovered charging gun has a priority identifier, and as the charging status corresponding to the charging gun changes, etc., the priority identifier of the to-be-recovered charging gun may change compared to the start of power adjustment, so it is necessary to re-determine the priority identifier of the to-be-recovered charging gun.
S3232, determining a power recovery sequence according to the priority identifier.

Each priority identifier has a different priority when recovering power, thus, all to-be-recovered charging guns can be sorted according to the priority identifier to obtain the power recovery sequence.

In specific embodiments, the priority identifiers include four levels, corresponding to users with paused charging, users with priority charging, VIP users, and ordinary users respectively. In the power recovery sequence, first the charging guns corresponding to users who have paused charging are recovered, then the charging guns corresponding to VIP users are recovered, and finally the charging guns corresponding to users with priority charging are recovered; the charging guns corresponding to users who have paused charging do not participate in power recovery because their charging power has been completely reduced to 0.

The level of the priority identifier may not be limited to the four levels described in the above embodiments, the corresponding users can be increased, decreased or changed compared with the four types of users in the above embodiments, the corresponding priority is also not limited to the embodiments.
S3233, sequentially recovering power for each to-be-recovered charging gun according to the power recovery sequence.

In an embodiment, step S3233 includes:
S32331, determining the setpoint power and the minimum reserved power value of the to-be-recovered charging gun.
S32332, determining a maximum recoverable value of the to-be-recovered charging gun according to the setpoint power and the minimum reserved power value.

The minimum setpoint power of the to-be-recovered charging gun during normal operation is the minimum reserved power value, that is, the minimum setpoint power of the to-be-recovered charging gun after power reduction; thus, it can be determined that the maximum recoverable value of the to-be-recovered charging gun is the result of the setpoint power value minus the minimum reserved power value, that is, maximum recoverable value=setpoint power value−minimum reserved power value.
S32333, recovering power for the to-be-recovered charging gun according to the maximum recoverable value or the receivable power value.

Since both the maximum recoverable value and the receivable power value exert a constraint on the recovered power, that is, the allocated reduced power for the to-be-recovered charging gun cannot exceed the maximum recoverable value to prevent the setpoint power of the charging gun from being lower than the minimum reserved power value, resulting in the charging gun stopping working. Meanwhile, the recovered reduced power cannot exceed the receivable power value; otherwise, the target charging gun receives excessive power, resulting in the target charging pile generating power redundancy and reducing the overall charging efficiency.

Thus, to solve the above problem, S32333 further includes the following steps:
S323331, determining whether the maximum recoverable value is greater than the receivable power value.
S323332, in response to determining that the maximum recoverable value is greater than or equal to the receivable power value, reducing the setpoint power of the to-be-recovered charging gun according to the receivable power value.

When the maximum recoverable value is greater than or equal to the receivable power value, it is indicated that the to-be-recovered charging gun is sufficient to fully release the receivable power value of the target charging gun; at this time, the setpoint power of the to-be-recovered charging gun is reduced by the receivable power value, and the setpoint power of the target charging gun is increased to reach the reported power value.
S323333, in response to determining that the maximum recoverable value is less than the receivable power value, reducing the setpoint power of the to-be-recovered charging gun according to the maximum recoverable value.

When the maximum recoverable value is less than the receivable power value, it is indicated that even if the setpoint power of the to-be-recovered charging gun is reduced to the minimum reserved power value, it still cannot fully provide all the receivable power values required by the target charging gun. At this time, the setpoint power of the to-be-recovered charging gun is reduced with the maximum recoverable value, and the setpoint power of the to-be-recovered charging gun is reduced to reach the minimum reserved power value.
S323334, recalculating the receivable power value of the target charging gun according to the maximum recoverable value and the receivable power value.

When reducing the setpoint power of the to-be-recovered charging gun by the maximum recoverable value, it is indicated that the to-be-recovered charging gun cannot fully provide the receivable power value required by the target charging gun; therefore, it is necessary to recover power for another to-be-recovered charging gun, and thus it is necessary to recalculate the receivable power value of the target charging gun.

In an embodiment, the receivable power value of the target charging gun at this time is the original receivable power value minus the maximum receivable value of the recovered to-be-recovered charging gun, that is, recalculated receivable power value=original receivable power value−maximum recoverable value.

In the embodiment, the first to-be-recovered charging gun is defined as a charging gun among the to-be-recovered charging guns whose power has not been recovered, and the second to-be-recovered charging gun is defined as a charging gun among the to-be-recovered charging guns whose power has been recovered. The original receivable power value of the target charging gun is 4 kw, the maximum recovered power value of the second to-be-allocated charging gun is 1 kw, so the recalculated receivable power value is 3 kw; for the first to-be-recovered charging gun, the recalculated 3 kw is used as the receivable power value for subsequent calculations and judgments.

In some embodiments of the present disclosure, there may be multiple first to-be-recovered charging guns, and the specific number thereof is not limited. For example, in the present embodiment, the maximum recovered power values of the two first to-be-recovered charging guns are 2 kw and 1 kw respectively, and then the recalculated receivable power value is 1 kw.
S323335, recovering power for a first to-be-recovered charging gun according to the recalculated receivable power value.

In an embodiment, in this step, it is necessary to judge again the magnitude between the receivable power value of the target charging gun and the maximum recoverable value of the first to-be-recovered charging gun, and allocate power to the first to-be-recovered charging gun according to the judgment result; the specific process thereof can refer to step S323, and will not be repeated here.

In some embodiments, after step S323, the method further includes:
S324, recovering power for the to-be-recovered charging pile according to the receivable power value. The method specifically includes:
S3241, determining whether the receivable power value is available in the target charging pile.

After the target charging pile recovers power from all its to-be-recovered charging guns, at this point, it is still possible that the setpoint power of the target charging gun has not yet reached the reported power, requiring further recovering power. Specifically, the target charging pile still has a receivable power value, that is, the receivable power value is greater than 0; therefore, it is necessary to further judge whether the receivable power value is 0; if it is not 0, the following step S3242 is executed; if it is 0, the following step S3245 is executed.
S3242, in response to determining that the receivable power value is available in the target charging pile, determining a group including the target charging pile as a target group.
S3243, determining a charging pile in a to-be-recovered state in the target group as a to-be-recovered charging pile.

Due to the structure of the power adjustment system, the algorithm difficulty and loss of power recovery among charging piles belonging to the same group are both superior to those of power recovery among charging piles in different groups. Therefore, when there is a receivable power value in the target charging pile, the group containing the target charging pile is determined as the target group, and the charging piles in the same target group that are in the to-be-recovered state are determined as to-be-recovered charging piles.

In an embodiment, it is determined whether the setpoint power of each charging pile in the target group has reached the minimum reserved power of the charging pile; if so, it is determined that the charging pile is not a to-be-recovered charging pile; if not, it is determined that the charging pile is a to-be-recovered charging pile.
S3244, recovering power for the to-be-recovered charging pile according to the receivable power value.

For the charging gun of the to-be-recovered charging pile, power is recovered for the charging gun according to the receivable power value; the specific process can refer to steps S322 and S323, which will not be repeated here.
S3245, when no receivable power value is available for the target charging pile, ending step S320.

When there is no receivable power value in the target charging pile, it is indicated that the setpoint power of the target charging gun has been adjusted to the reported power, and the target charging pile has completed the power recovery operation, so the power recovery operation step can be ended.

In some embodiments, after step S324, the method further includes:
S325, recovering power for the to-be-recovered group according to the receivable power value. The method specifically includes:
S3251, determining whether the target group has a receivable power value.

After the target group recovers power from all its to-be-recovered charging piles, at this point, it is still possible that the setpoint power of the target charging gun has not yet reached the reported power, requiring further receiving power. Specifically, the target group still has a receivable power value, that is, the receivable power value is greater than 0; therefore, it is necessary to further judge whether the receivable power value is 0; if it is not 0, the following step S3252 is executed; if it is 0, the following step S3254 is executed.
S3252, when the receivable power value is available in the target group, determining other groups in the to-be-recovered state as to-be-recovered groups.

In an embodiment, it is judged whether the overall setpoint power of groups other than the target group has reached the minimum reserved power value of the group; if so, it is determined that the group is not a to-be-allocated group; if not, it is determined that the group is a to-be-allocated group.
S3253, recovering power for the to-be-recovered group according to the receivable power value.

For the charging piles of the to-be-recovered group, refer to step S3243 to determine the to-be-recovered charging piles in the to-be-recovered group, and then power is recovered for the charging guns in the to-be-recovered charging piles according to the receivable power value. The specific process can refer to steps S322 and S323, which will not be repeated here.

In some embodiments of the present disclosure, if after step S3253, the target charging gun still has a receivable power value, that is, the receivable power value is greater than 0, the final setpoint power of the target charging gun after power release in step S320 is the setpoint power plus the recovered power value, or can be calculated as the reported power minus the unrecovered power.

In some embodiments of the present disclosure, if after step S3253, the final setpoint power of the target charging gun is still lower than the reported power and the deviation between the two is greater than the preset threshold, making the target charging gun still belong to the type with abnormally high setpoint power, in order to avoid overload of the target charging pile, adjust the priority identifier corresponding to the target charging gun to the suspended charging user level, reduce the final setpoint power of the target charging gun to 0, and wait for maintenance personnel to inspect and repair.
S3254, when no receivable power value is available in the target group, ending step S320.

When there is no receivable power value in the target group, it is indicated that the setpoint power of the target charging gun has been adjusted to the reported power, and the target group has completed the power recovery operation, so the power recovery operation step can be ended.

In some embodiments, before step S21, the method further includes:
S201, acquiring user information corresponding to the target charging gun.

In an embodiment, the user information includes the type of a user, and the type of the user is, for example, one of a VVIP user, a VIP user, ordinary user, a blacklist user, and a whitelist user.
S202, generating the priority identifier for the target charging gun according to the user information.

The priority identifier is used to determine the setpoint power of the target charging gun and an order of power recovery. Specifically, when determining the setpoint power, the setpoint power is allocated in sequence according to the order of the VVIP user, the VIP user, and the ordinary user; when recovering power, the power is recovered in the order of the ordinary user, the VIP user, and the VVIP user.

In some other embodiments, before step S21, the method further includes:
S203, acquiring user information corresponding to the target charging gun.

In an embodiment, the user information includes scheduled charging time of the user.

In some embodiments, the user can send the scheduled charging time to the power adjustment system through an intelligent terminal such as a mobile phone or a laptop computer. After acquiring the scheduled charging time, the power adjustment system adjusts the setpoint power of the target charging gun corresponding to the user according to the scheduled charging time, so that the user's device to be charged can complete the charging task within the scheduled charging time.
S204, acquiring an estimated charging time of the target charging gun.

The power adjustment system generates the estimated charging time of the target charging gun according to the reported power collected by the target charging gun in real time, combined with the charging task or charging progress of the device to be charged.

In an embodiment, the reported power of the target charging gun is 5 kw, the charging task is to charge the battery from 20% power to 98%, and the estimated charging time calculated according to the preset charging curve is 40 min.
S205, generating the priority identifier for the target charging gun according to the scheduled charging time and the estimated charging time.

In an embodiment, the scheduled charging time set by the user is 30 min, and the estimated charging time calculated by the power adjustment system is 40 min, so the priority identifier of the target charging gun corresponding to the user is set to the priority charging user level.

In another embodiment, the scheduled charging time set by the user is 30 min, and the estimated charging time calculated by the power adjustment system is 40 min, so the priority identifier of the target charging gun corresponding to the user is set to the ordinary charging user level.

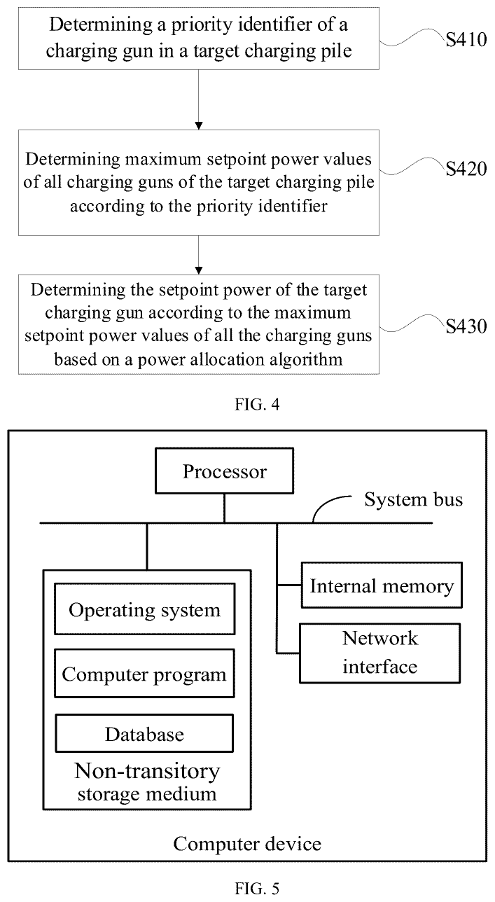

FIG. 4 is a schematic flowchart of determining a setpoint power of a target charging gun according to a priority identifier according to an embodiment of the present disclosure.
S410, determining a priority identifier of a charging gun in a target charging pile.
S420, determining maximum setpoint power values of all charging guns of the target charging pile according to the priority identifier.

In an embodiment, step S420 includes:
S421, determining the number of charging guns corresponding to each priority identifier.

In some embodiments, the target charging pile includes 4 charging guns, corresponding to 4 user types with priority identifiers: a priority charging user, a suspended charging user, a VIP user, and an ordinary user. Thus, it can be determined that the quantity of the charging guns corresponding to respective priority identifiers is 1.
S422, sorting the charging guns according to the priority identifier to obtain a power allocation sequence.

In some embodiments, the power allocation sequence first determines the maximum setpoint power value for the suspended charging users, secondly determines the maximum setpoint power value for the charging users with priority, then determines the maximum setpoint power value for the VIP users, and finally determines the maximum setpoint power value for the ordinary users.

It can be understood that in some other embodiments, the power allocation sequence corresponding to the priority identifier can be changed in order, for example, first determine the maximum setpoint power value for VIP users, and then determine the maximum setpoint power value for charging users with priority.
S423, sequentially determining the maximum setpoint power value of each charging gun according to the power allocation sequence and the priority identifier.

In some embodiments, the power upper limit of the target charging pile is 20 kw, the minimum reserved power of each charging gun is 3 kw, the maximum power value of the charging gun is 10 kw, and the target charging pile includes 4 charging guns, corresponding to the priority charging user, the suspended charging user, the VIP user, and the ordinary user.

According to the power allocation sequence, first the maximum setpoint power value of the charging gun for the suspended charging user is determined as 0. Secondly, calculation is performed according to the formula: maximum setpoint power value for charging users with priority=(charging pile power upper limit−minimum reserved power value×quantity of charging guns for users with low priority identifiers)/(quantity of charging guns for charging users with priority), that is, (20−3×2)/1=14 kw.

The quantity of the charging guns with low priority identifiers does not include the quantity of the charging guns for suspended charging users.

Since the value 14 kw is greater than the maximum power value 10 kw of the charging gun, it is calculated according to the maximum power value 10 kw of the charging gun.

Further, since there are charging users with priority in the power allocation sequence, the priority identifier of VIP users is reduced to the same level as that of the ordinary users, that is, both the VIP users and the ordinary users calculate the maximum setpoint power value according to the minimum reserved power value.

In other embodiments, even if there are charging users with priority in the power allocation sequence, the priority identifier of the VIP users is still higher than that of the ordinary users, and the maximum setpoint power value for the VIP users is calculated according to the formula: (remaining power upper limit of charging pile−minimum reserved power value×quantity of the charging guns for the users with low priority identifiers)/(quantity of the charging guns for the VIP users), that is, ((20−14)−3×1)/1=3 kw.

Finally, if there are no charging users with priority and VIP users in the power allocation sequence, the maximum setpoint power value for the ordinary users=the charging pile power upper limit/quantity of the charging guns for the ordinary users; if there are, the maximum setpoint power value of the charging guns corresponding to ordinary users is directly set according to the minimum reserved power value.
S430, determining the setpoint power of the target charging gun according to the maximum setpoint power values of all the charging guns based on a power allocation algorithm.

The power allocation algorithm includes an average allocation algorithm, a weighted average algorithm, and a first-in-first-out algorithm, and the selection of a specific algorithm is determined by parameters.

In an embodiment, in the process of executing the power allocation algorithm, the setpoint power of each charging gun of the target charging pile is allocated and determined in sequence according to the priority identifier. For example, first allocation is performed to the charging guns of the charging users with priority, then to the charging guns of the VIP users, and finally to the charging guns of the ordinary users.

In some embodiments, the target charging pile first allocates power to all charging guns corresponding to charging users with priority with priority identifiers based on the power allocation algorithm. After determining the setpoint power of the charging guns for the charging users with priority, the target charging pile allocates power to the VIP users based on the power allocation algorithm according to the remaining allocable power value. The remaining allocable power value is the maximum power value of the target charging pile minus the total setpoint power value allocated to the charging users with priority. If the remaining allocable power value is 0, it is directly allocated to the VIP users according to the minimum reserved power value to determine the setpoint power value.

It can be understood that in the present embodiment, the setpoint power logic of the charging guns corresponding to the ordinary users is the same as that of the VIP users, and the only difference is that the priority identifier of the ordinary users is lower than that of the VIP users, so details are not described herein.

It can be seen that the following technical effects can be achieved through the technical solution of the present disclosure: first, the priority identifier of the target charging gun is determined, where the target charging pile includes multiple charging guns including the target charging gun; second, the setpoint power of the target charging gun is determined according to the priority identifier; then, the reported power of the target charging gun is acquired; finally, the target charging pile is controlled to perform a power release operation or a power recovery operation on the target charging gun according to the setpoint power and the reported power. Therefore, a real-time dynamic adjustment of the power of the target charging gun is realized. By combining the priority identifier with real-time monitoring of the charging guns, while the setpoint power of the target charging gun is determined according to the priority identifier, power release or power recovery is performed in response to the target charging gun which is monitored to be abnormal, thereby allowing the target charging gun to operate normally while achieving the overall charging efficiency and stability of the target charging pile.

An embodiment of the present disclosure further provides a non-transitory computer-readable storage medium storing a computer program including program commands which, when executed by a computer, cause the computer to perform the method according to the preceding embodiments.

An embodiment of the present disclosure further provides a power adjustment system based on charging piles, which includes a charging management device and a charging station, where the charging station includes at least one charging group, each charging group includes at least two charging piles, the charging management device is communicatively connected to the charging station, and the charging management device is configured to execute the power adjustment method based on charging piles according to the foregoing embodiment.

An embodiment of the present disclosure further provides an electronic device, including a memory, a processor, and a computer program stored in the memory and executable on the processor, where the processor implements the power adjustment method based on charging piles according to the foregoing embodiments when executing the computer program.

In an embodiment, further provided is a computer device, which may be a server, the internal structure of which may be as shown in FIG. 5. The computer device includes a processor, a memory, a network interface, and a database connected through a system bus. The processor of the computer device is configured to provide computing and control capabilities. The memory of the computer device includes a non-volatile storage medium and an internal memory. The non-volatile storage medium stores an operating system, a computer program, and a database. The internal memory provides an environment for the operation of the operating system and the computer program in the non-volatile storage medium. The database of the computer device is used to store data to be saved in the power adjustment method based on charging piles. The network interface of the computer device is used to communicate with an external terminal through a network connection. The computer program, when executed by the processor, implements a power adjustment method based on charging piles.

All or part of the flows of the methods of the embodiments described above may be implemented by hardware instructions of a computer program, which may be stored in a non-volatile computer-readable storage medium, and when executed, may include the flows of the embodiments of the methods described above. Any reference to memory, storage, database or other media used in the embodiments provided in the present disclosure may include non-volatile and/or volatile memories. Non-volatile memory may include read-only memory (ROM), programmable ROM (PROM), electrically programmable ROM (EPROM), electrically erasable programmable ROM (EEPROM), or flash memory. Volatile memory may include random access memory (RAM) or external cache memory. By way of illustration and not limitation, RAM is available in various forms such as static RAM (SRAM), dynamic RAM (DRAM), synchronous DRAM (SDRAM), double data rate SDRAM (DDRSDRAM), enhanced SDRAM (ESDRAM), Synchlink DRAM (SLDRAM), Rambus direct RAM (RDRAM), direct memory bus dynamic RAM (DRDRAM), and memory bus dynamic RAM (RDRAM), etc.

For convenience and conciseness of description, only the above-mentioned division of functional units and modules is exemplified, and in practical applications, the above-mentioned allocation of functions can be performed by different functional units and modules, i.e. dividing the internal structure of the apparatus into different functional units or modules, as required, to perform all or part of the functions described above.

The above embodiments serve to illustrate the technical solutions of the present disclosure as examples, rather than to restrict the principles of the present disclosure. Although the present disclosure has been described in detail with reference to the preceding embodiments, all other embodiments, including modifications based on the principles of the present disclosure, fall within the protection scope of the present disclosure. Such modifications or replacements do not cause the essence of the corresponding technical solutions to depart from the spirit and scope of the technical solutions of each embodiment of the present disclosure, and all such modifications or replacements shall be included within the protection scope of the present disclosure.

Want is claimed is:

1. A power adjustment method based on charging piles, comprising:
determining a priority identifier of a target charging gun in a target charging pile;
determining a setpoint power of the target charging gun based on the priority identifier;
acquiring a reported power of the target charging gun; and
controlling the target charging pile to perform a power release operation or a power recovery operation on the target charging gun based on the setpoint power and the reported power.

2. The method according to claim 1, wherein controlling the target charging pile to perform the power release operation or the power recovery operation on the target charging gun based on the setpoint power and the reported power comprises:
in response to determining that the setpoint power is greater than the reported power, controlling the target charging pile to perform the power release operation on the target charging gun; or in response to determining that the setpoint power is less than the reported power, controlling the target charging pile to perform the power recovery operation on the target charging gun.

3. The method according to claim 2, wherein controlling the target charging pile to perform the power release operation on the target charging gun comprises:
calculating a releasable power value of the target charging gun according to the setpoint power and the reported power;
determining a charging gun in a to-be-received state in the target charging pile as a to-be-allocated charging gun; and
allocating power to the to-be-allocated charging gun according to the releasable power value.

4. The method according to claim 3, wherein determining the charging gun in the to-be-received state in the target charging pile as the to-be-allocated charging gun comprises:
acquiring the setpoint power and a maximum power value of the charging gun in the target charging pile, and in response to determining that the setpoint power is less than the maximum power value, determining the charging gun as the to-be-allocated charging gun; or,
acquiring the setpoint power and the reported power of the charging gun in the target charging pile, and in response to determining that a difference between the setpoint power and the reported power is less than a first preset threshold, determining the charging gun as the to-be-allocated charging gun.

5. The method according to claim 3, wherein allocating power to the to-be-allocated charging gun according to the releasable power value comprises:
determining the setpoint power and the maximum power value of the to-be-allocated charging gun;
determining a maximum receivable value of the to-be-allocated charging gun according to the setpoint power and the maximum power value; and
allocating power to the to-be-allocated charging gun according to the maximum receivable value or the releasable power value.

6. The method according to claim 5, wherein allocating power to the to-be-allocated charging gun according to the maximum receivable value or the releasable power value comprises:
in response to determining that the maximum receivable value is less than the releasable power value, increasing the setpoint power of the to-be-allocated charging gun according to the maximum receivable value; or
in response to determining that the maximum receivable value is greater than or equal to the releasable power value, increasing the setpoint power of the to-be-allocated charging gun according to the releasable power value.

7. The method according to claim 6, after increasing the setpoint power of the to-be-allocated charging gun according to the maximum receivable value, further comprising:
recalculating the releasable power value of the target charging gun according to the maximum receivable value and the releasable power value; and
allocating power to a first to-be-allocated charging gun according to the recalculated releasable power value, wherein the first to-be-allocated charging gun is a charging gun among a plurality of to-be-allocated charging guns that have not been allocated power yet.

8. The method according to claim 3, after allocating power to the to-be-allocated charging gun according to the releasable power value, further comprising:
in response to determining that the releasable power value is available in the target charging pile, determining a group including the target charging pile as a target group; determining the charging pile in the to-be-received state in the target group as the to-be-allocated charging pile, and allocating power to the to-be-allocated charging pile according to the releasable power value; and,
in response to determining that the releasable power value is available in the target group, determining other groups in the to-be-received state as to-be-allocated groups, and allocating power to the to-be-allocated groups according to the releasable power value.

9. The method according to claim 2, wherein controlling the target charging pile to perform the power recovery operation on the target charging gun comprises:
calculating a receivable power value of the target charging gun according to the setpoint power and the reported power;
determining a charging gun in a to-be-recovered state in the target charging pile as a to-be-recovered charging gun; and
recovering power for the to-be-recovered charging gun according to the receivable power value.

10. The method according to claim 9, wherein determining the charging gun in the to-be-recovered state in the target charging pile as the to-be-recovered charging gun comprises:
acquiring the setpoint power and a minimum reserved power value of the charging gun in the target charging pile, and in response to determining that the setpoint power is greater than the minimum reserved power value, determining the charging gun as the to-be-recovered charging gun; or,
acquiring the setpoint power and the reported power of the charging gun in the target charging pile, and in response to determining that a difference between the setpoint power and the reported power is greater than a second preset threshold, determining the charging gun as the to-be-recovered charging gun.

11. The method according to claim 9, wherein recovering power for the to-be-recovered charging gun according to the receivable power value comprises:
determining the priority identifier of the to-be-recovered charging gun;
determining a power recovery sequence according to the priority identifier; and
recovering power for each of a plurality of to-be-recovered charging guns in sequence according to the power recovery sequence.

12. The method according to claim 11, wherein recovering power for each of the plurality of to-be-recovered charging guns in sequence according to the power recovery sequence comprises:
determining the setpoint power and the minimum reserved power value of the to-be-recovered charging gun;
determining a maximum recoverable value of the to-be-recovered charging gun according to the setpoint power and the minimum reserved power value; and
recovering power for the to-be-recovered charging gun according to the maximum recoverable value or the receivable power value.

13. The method according to claim 11, wherein recovering power for the to-be-recovered charging gun according to the maximum recoverable value or the receivable power value comprises:
in response to determining that the maximum recoverable value is greater than or equal to the receivable power value, reducing the setpoint power of the to-be-recovered charging gun according to the receivable power value; or
in response to determining that the maximum recoverable value is less than the receivable power value, reducing the setpoint power of the to-be-recovered charging gun according to the maximum recoverable value.

14. The method according to claim 13, after reducing the setpoint power of the to-be-recovered charging gun according to the maximum recoverable value, further comprising:
recalculating the receivable power value of the target charging gun according to the maximum recoverable value and the receivable power value; and
recovering power for a first to-be-recovered charging gun according to the recalculated receivable power value, wherein the first to-be-recovered charging gun is a charging gun in the plurality of to-be-recovered charging guns that have not been recovered power yet.

15. The method according to claim 9, after recovering power to the to-be-recovered charging gun according to the receivable power value, further comprising:
in response to determining that the receivable power value is available in the target charging pile, determining a group including the target charging pile as a target group; determining a charging pile in the to-be-recovered state in the target group as a to-be-recovered charging pile; recovering power for the to-be-recovered charging pile according to the receivable power value; and,
determining whether the receivable power value is available in the target group; in response to determining that the receivable power value is available in the target group, determining other groups in the to-be-recovered state as to-be-recovered groups; and recovering power for the to-be-recovered groups according to the receivable power value.

16. The method according to claim 1, before determining the priority identifier of a target charging gun, further comprising:
acquiring user information corresponding to the target charging gun, wherein the user information comprises a user type, and generating the priority identifier for the target charging gun according to the user information; or,
acquiring user information corresponding to the target charging gun, wherein the user information comprises a scheduled charging time of a user; acquiring an estimated charging time of the target charging gun, and generating the priority identifier for the target charging gun according to the scheduled charging time and the estimated charging time.

17. The method according to claim 1, wherein determining the setpoint power of the target charging gun based on the priority identifier comprises:
determining the priority identifier of the charging gun in the target charging pile;
determining maximum setpoint power values of charging guns in the target charging pile according to the priority identifier; and
determining the setpoint power of the target charging gun according to the maximum setpoint power values of the charging guns based on a power allocation algorithm.

18. The method according to claim 17, wherein determining the maximum setpoint power values of the charging guns of the target charging pile according to the priority identifier comprises:
sorting the charging guns according to the priority identifier to obtain a power allocation sequence; and
sequentially determining a maximum setpoint power value of each charging gun according to the power allocation sequence and the priority identifier.

19. An electronic device, comprising a memory, a processor and a computer program stored in the memory and capable of running on the processor, wherein the processor, when executing the computer program, performs acts comprising:
determining a priority identifier of a target charging gun in a target charging pile;
determining a setpoint power of the target charging gun based on the priority identifier;
acquiring a reported power of the target charging gun; and
controlling the target charging pile to perform a power release operation or a power recovery operation on the target charging gun based on the setpoint power and the reported power.

20. A non-transitory computer-readable storage medium, storing a computer program, wherein the computer program, when executed by a processor, cause the processor to perform acts comprising:
determining a priority identifier of a target charging gun in a target charging pile;
determining a setpoint power of the target charging gun based on the priority identifier;
acquiring a reported power of the target charging gun; and
controlling the target charging pile to perform a power release operation or a power recovery operation on the target charging gun based on the setpoint power and the reported power.
